(19) United States
(12) Patent Application Publication
(10) Pub. No.: US 2026/0260204 A1
(43) Pub. Date: Sep. 3, 2026

(54) INFORMATION PROCESSING SYSTEM, INFORMATION PROCESSING DEVICE, INFORMATION PROCESSING METHOD, AND PROGRAM

(71) Applicant: AERONEXT INC., Tokyo (JP)

(72) Inventors: Shuji KAWAI, Tokyo (JP); Tadanari HIGUCHI, Gifu (JP); Keisuke TOJI, Tokyo (JP); Takuya HORI, Tokyo (JP)

(21) Appl. No.: 18/878,902

(22) PCT Filed: Jun. 28, 2023
(86) PCT No.: PCT/JP2023/024015

§ 371 Date: Dec. 26, 2024

(30) Foreign Application Priority Data
Jun. 30, 2022 (JP) 2022-105539

(51) Int. Cl. G06Q 10/083

(52) U.S. Cl. CPC G06Q 10/0843

(57) ABSTRACT

An information processing system includes: a determination unit that determines, based on request details included in a delivery request regarding delivery or collection of a package registered by a delivery client, whether having a delivery person responding to the delivery request satisfies a condition regarding delivery efficiency of the delivery person; and a generation unit that generates, based on a determination made by the determination unit that the condition is not satisfied, delivery instruction information regarding delivery or collection of the package by other delivery means different from the delivery person.

### FIELD

The present invention relates to an information processing system, an information processing device, an information processing method, and a program.

### BACKGROUND

In recent years, technologies have been developed in regard to delivery work for delivery or collection of packages requested by a certain user, which enables a delivery person responding to the delivery work to efficiently deliver or collect the packages. For example, Patent Literature 1 discloses a technique that acquires the loading capacity of each of one or a plurality of circulation services circulating through three bases, and determines whether to change the operation plan of the circulation services based on the acquired loading capacity.

### CITATION LIST

### Patent Literature

Patent Literature 1: Japanese Patent Application Laid-open No. 2020-52525

### SUMMARY

### Technical Problem

However, the technology described in Patent Literature 1 increases or decreases the number of circulation services in accordance with the loading capacity, and does not take into account the delivery efficiency of the delivery person who delivers packages by the circulation services, which may vary depending on the request details included in the delivery requests of packages.

The present invention is designed in view of the aforementioned circumstances, and it is an object thereof to provide a new and improved information processing system, information processing device, information processing method, and program capable of further improving the delivery efficiency of the delivery person.

### Solution to Problem

In order to overcome such issues, one aspect of the present invention provides an information processing system including: a determination unit that determines, based on request details included in a delivery request regarding delivery or collection of a package registered by a delivery client, whether having a delivery person responding to the delivery request satisfies a condition regarding delivery efficiency of the delivery person; and a generation unit that generates, based on a determination made by the determination unit that the condition is not satisfied, delivery instruction information regarding delivery or collection of the package by other delivery means different from the delivery person.

Furthermore, in order to overcome such issues, another aspect of the present invention provides an information processing device including: a determination unit that determines, based on request details included in a delivery request regarding delivery or collection of a package registered by a delivery client, whether having a delivery person responding to the delivery request satisfies a condition regarding delivery efficiency of the delivery person; and a generation unit that generates, based on a determination made by the determination unit that the condition is not satisfied, delivery instruction information regarding delivery or collection of the package by other delivery means different from the delivery person.

In order to overcome such issues, still another aspect of the present invention provides an information processing method executed by a computer, the information processing method including: determining, based on request details included in a delivery request regarding delivery or collection of a package registered by a delivery client, whether having a delivery person responding to the delivery request satisfies a condition regarding delivery efficiency of the delivery person; and generating, based on a determination that the condition is not satisfied, delivery instruction information regarding delivery or collection of the package by other delivery means different from the delivery person.

In order to overcome such issues, yet another aspect of the present invention provides a program causing a computer to execute: a determination function that determines, based on request details included in a delivery request regarding delivery or collection of a package registered by a delivery client, whether having a delivery person responding to the delivery request satisfies a condition regarding delivery efficiency of the delivery person; and a generation function that generates, based on a determination made by the determination function that the condition is not satisfied, delivery instruction information regarding delivery or collection of the package by other delivery means different from the delivery person.

### Advantageous Effects of Invention

As described above, it is possible with the present invention to further improve the delivery efficiency of the delivery person.

### BRIEF DESCRIPTION OF DRAWINGS

FIG. 1 is an explanatory diagram for describing an overview of an information processing system according to an embodiment.

FIG. 2 is an explanatory diagram for describing an example of delivery slots according to the present embodiment.

FIG. 3 is an explanatory diagram for describing an example of a functional configuration of an information terminal 20 according to the present embodiment.

FIG. 4 is an explanatory diagram for describing an example of a functional configuration of an operation management server 30 according to the present embodiment.

FIG. 5 is an explanatory diagram for describing an example of a functional configuration of a schedule management server 40 according to the present embodiment.

FIG. 6 is an explanatory diagram for describing an example of processing for determining whether a condition regarding delivery efficiency is satisfied.

FIG. 7 is an explanatory diagram for describing another example of processing for determining whether a condition regarding delivery efficiency is satisfied.

FIG. 8 is an explanatory diagram for describing other examples of a collection location and a receiving location according to the present embodiment.

FIG. 9 is an explanatory diagram for describing an example of operation processing of the operation management server 30 according to the present embodiment.

FIG. 10 is an explanatory diagram for describing an example of a hardware configuration of the operation management server 30 according to the present embodiment.

### DESCRIPTION OF EMBODIMENTS

The contents of an embodiment of the present invention will be listed and described. An information processing system and the like according to the embodiment has the following configurations.

### Item 1

An information processing system including:
a determination unit that determines, based on request details included in a delivery request regarding delivery or collection of a package registered by a delivery client, whether having a delivery person responding to the delivery request satisfies a condition regarding delivery efficiency of the delivery person; and
a generation unit that generates, based on a determination made by the determination unit that the condition is not satisfied, delivery instruction information regarding delivery or collection of the package by other delivery means different from the delivery person.

### Item 2

The information processing system according to item 1, further including a communication unit that transmits the delivery instruction information generated by the generation unit to an external device.

### Item 3

The information processing system according to item 2, in which the external device includes an information terminal used by an administrator that manages an unmanned vehicle.

### Item 4

The information processing system according to item 2, in which the external device includes an unmanned vehicle.

### Item 5

The information processing system according to item 4, in which the delivery person delivers the package using a mobile body.

### Item 6

The information processing system according to item 5, in which the mobile body includes a vehicle that travels on a land route.

### Item 7

The information processing system according to item 6, in which the unmanned vehicle includes a mobile body that autonomously travels on the land route.

### Item 8

The information processing system according to item 6, in which the unmanned vehicle includes a mobile body that autonomously travels on a route different from the land route.

### Item 9

The information processing system according to item 8, in which the unmanned vehicle includes an aircraft that autonomously flies on an air route.

### Item 10

The information processing system according to any one of items 1 to 9, in which the determination unit determines whether the condition is satisfied, based on a receiving location of the package included in the request details.

### Item 11

The information processing system according to any one of items 1 to 9, in which the determination unit determines whether the condition is satisfied, based on a delivery area of the delivery person.

### Item 12

The information processing system according to any one of items 1 to 9, in which the determination unit determines that the condition is not satisfied when a prescribed demand that affects a delivery plan of the delivery person is included in the request details.

### Item 13

The information processing system according to any one of items 3 to 9, in which the determination unit determines that the condition is not satisfied when a delivery start location of the package is within a prescribed range from a location of the unmanned vehicle that is capable of being used for delivery of the package.

### Item 14

The information processing system according to any one of items 3 to 9, in which the determination unit determines that the condition is not satisfied when a delivery start location of the package is same as a location of the unmanned vehicle that is capable of being used for delivery or collection of the package.

### Item 15

The information processing system according to any one of items 3 to 9, in which the generation unit generates other delivery instruction information regarding delivery or collection of the package to be performed by delivery means of the delivery person, based on a determination made by the determination unit that the condition is satisfied.

### Item 16

The information processing system according to item 15, in which the communication unit transmits the other delivery instruction information to a terminal used by the delivery person.

### Item 17

An information processing device including:
a determination unit that determines, based on request details included in a delivery request regarding delivery or collection of a package registered by a delivery client, whether having a delivery person responding to the delivery request satisfies a condition regarding delivery efficiency of the delivery person; and
a generation unit that generates, based on a determination made by the determination unit that the condition is not satisfied, delivery instruction information regarding delivery or collection of the package by other delivery means different from the delivery person.

### Item 18

An information processing method executed by a computer, the information processing method including:
determining, based on request details included in a delivery request regarding delivery or collection of a package registered by a delivery client, whether having a delivery person responding to the delivery request satisfies a condition regarding delivery efficiency of the delivery person; and
generating, based on a determination that the condition is not satisfied, delivery instruction information regarding delivery or collection of the package by other delivery means different from the delivery person.

### Item 19

A program causing a computer to execute:
a determination function that determines, based on request details included in a delivery request regarding delivery or collection of a package registered by a delivery client, whether having a delivery person responding to the delivery request satisfies a condition regarding delivery efficiency of the delivery person; and
a generation function that generates, based on a determination made by the determination function that the condition is not satisfied, delivery instruction information regarding delivery or collection of the package by other delivery means different from the delivery person.

Hereinafter, a preferable embodiment of the present invention will be described in detail with reference to the accompanying drawings. In the present specification and drawings, duplicate explanations of structural components having substantially identical functional configuration will be omitted by applying the same reference signs thereto.

Furthermore, in the present specification and drawings, mobile bodies used by delivery persons are distinguished as necessary into each mobile body, such as a manned mobile body 10A and an unmanned vehicle 10B that moves under autonomous control or by remote control.

However, when there is no particular need to distinguish the mobile bodies, each mobile body is simply referred to as a mobile body 10. Also, information terminals are distinguished as necessary into each information terminal, such as a delivery person terminal 20A that is used by a delivery person who delivers or collects packages and a client terminal 20B that is used by a client who makes a request for delivery or collection of packages. However, when there is no particular need to distinguish the information terminals, each information terminal is simply referred to as an information terminal 20.

### 1. Overview of Information Processing System

One embodiment of the present invention relates to an information processing system that can further improve the delivery efficiency of the delivery person regarding delivery or collection of packages.

### 1.1. Overview

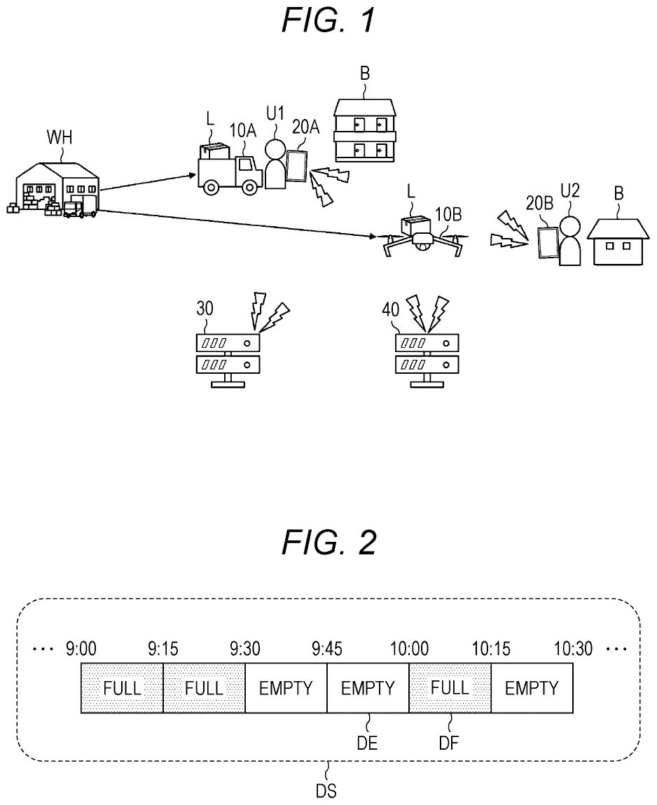

FIG. 1 is an explanatory diagram for describing an overview of the information processing system according to the present embodiment. As illustrated in FIG. 1, for example, the information processing system according to the present embodiment includes mobile bodies 10, information terminals 20, an operation management server 30, and a schedule management server 40.

The mobile bodies 10, the information terminals 20, the operation management server 30, and the schedule management server 40 are connected to each other via a network.

### (Mobile Body 10)

The mobile body 10 according to the present embodiment is a mobile body used in delivery work such as delivery or collection of a package L. For example, the mobile body 10 is used when delivering the package L requested to be delivered by a client U2 from a warehouse WH where the package L is stored. Note that the mobile body 10 is not essential in the delivery work, and the delivery may be made on foot along with a cart (for example, a box cart, a basket cart, or the like), for example.

For example, the mobile body 10 includes a manned mobile body 10A used by a delivery person Ul who delivers or collects the package L.

For example, the manned mobile body 10A according to the present embodiment may be a vehicle (for example, a passenger car, a light truck, a cargo vehicle such as a light van, a motorcycle, a bicycle, a kickboard, or the like) that travels on a land route, as illustrated in FIG. 1. However, the manned mobile body 10A is not limited to a vehicle. For example, the manned mobile body 10A may be an aircraft that flies on an air route, or a vessel moving along a waterway such as a seaway or a river.

Furthermore, the mobile body 10 according to the present embodiment includes an unmanned vehicle 10B that moves under autonomous control or by remote control. For example, the unmanned vehicle 10B may move by autonomous control using input information such as locations of two points such as a start point (for example, the delivery start location of the package L or the moving start location of the unmanned vehicle 10B) and an end point (for example, the receiving location of the package L), or locations of three or more points further including a relay point (for example, the collection location of the package L in the case of delivery involving collection of the package L) and a return point (for example, the same location as the moving start location of the unmanned vehicle 10, or a different standby location and the like). Note that the input information used for autonomous control may include various kinds of information such as other via points and delivery routes.

The unmanned vehicle 10B may also be moved by remote control using operation information remotely input by an administrator who manages the unmanned vehicle 10B.

For example, the unmanned vehicle 10B may be an aircraft as illustrated in FIG. 1. For example, the aircraft may be a drone that flies under autonomous control or an unmanned aerial vehicle (UAV) that flies under remote control of an administrator.

The unmanned vehicle 10B according to the present embodiment is not limited to an aircraft. For example, the unmanned vehicle 10B may be an unmanned ground vehicle (UGV) or the like that travels on a land route, or it may be a vessel traveling on a waterway, such as a seaway or a river.

The manned mobile body 10A and the unmanned vehicle 10B may also be mobile bodies that can travel on at least two or more routes out of land route, waterway, and air route.

### (Information Terminal 20)

The information terminal 20 according to the present embodiment is a terminal used by parties involved in services related to delivery or collection. For example, the information terminal 20 may be any of various kinds of terminals such as a tablet terminal, a smartphone, a cellular phone, a personal handy-phone system (PHS), a personal digital assistant (PDA), a personal computer (PC), or the like.

For example, the information terminal 20 includes a delivery person terminal 20A used by the delivery person Ul who delivers or collects the package L. For example, the delivery person Ul may use the delivery person terminal 20A to check delivery instruction information including a delivery task based on the request details included in a delivery request registered by the client U2. In FIG. 1, the package L is delivered to the client U2 who makes the delivery request. However, it is not limited to such cases, and it may also be a package that is sent by a client as a sender and delivered to a recipient different from that client. In such a case, the delivery person Ul loads the package L onto the mobile body 10 or the like when leaving the warehouse WH or the like, and one or more delivery tasks may also be set in advance as a delivery plan in a prescribed order.

The information terminal 20 also includes a client terminal 20B that is used by the client U2 who requests delivery or collection of the package L. For example, the client U2 may use the client terminal 20B to register a delivery request for delivery or collection of the package L.

### (Operation Management Server 30)

The operation management server 30 according to the present embodiment is an example of the information processing device, and it is a server that manages the operation of the mobile body 10. For example, the operation management server 30 may be a general-purpose computer such as a workstation or a PC, or may also be a cloud server.

For example, the operation management server 30 determines whether having the delivery person Ul responding to a delivery request for delivery or collection registered by the client U2 satisfies the condition regarding the delivery efficiency of the delivery person Ul. A specific example related to making a determination of whether the condition regarding the delivery efficiency is satisfied will be described later.

Based on the determination that the condition regarding the delivery efficiency of the delivery person Ul is not satisfied, the operation management server 30 generates delivery instruction information regarding delivery or collection of the package L by other delivery means different from the delivery person Ul.

For example, when determined that the condition regarding the delivery efficiency of the delivery person U1 is not satisfied, the operation management server 30 generates delivery instruction information regarding the delivery or collection of the package L by the unmanned vehicle 10B that is other delivery means different from the delivery person Ul.

Furthermore, when determined that the condition regarding the delivery efficiency of the delivery person Ul is satisfied, the operation management server 30 may generate other delivery instruction information regarding the delivery or collection of the package L by the delivery person U1.

Although specific examples of delivery instruction information and other delivery instruction information will be described later, the delivery instruction information is information used for autonomous control or remote control movement of the unmanned vehicle 10B, for example, and may also include, for example, location information of a home B designated by the client U2 as the receiving location (or collection location) of the package L.

### (Schedule Management Server 40)

The schedule management server 40 according to the present embodiment is a server that manages various kinds of schedules related to delivery and collection. For example, the schedule management server 40 may be a general-purpose computer such as a workstation or a personal computer, or may also be a cloud server.

For example, the schedule management server 40 manages delivery plans and delivery schedules related to delivery and collection for the delivery person Ul. The schedule management server 40 also manages delivery plans and delivery schedules related to delivery and collection for the unmanned vehicle 10B.

For example, the schedule management server 40 receives, from the operation management server 30, the result of the determination as to whether the condition regarding the delivery efficiency is satisfied. Then, the schedule management server 40 may register the delivery schedule related to the delivery or collection of the package L in a delivery slot of the delivery plan of the delivery person Ul or the unmanned vehicle 10B delivering the package L according to the received determination result.

Note that a delivery slot is the time slot in which the unmanned vehicle 10B or the delivery person Ul responds to a delivery request. For example, a daily delivery plan of the unmanned vehicle 10B (or the delivery person Ul) is divided into prescribed delivery slots (for example, 15 minutes, 30 minutes, or the like for the unmanned vehicle, 1 hour or the like for the delivery person), and the unmanned vehicle 10B (or the delivery person U1) responds to, during the time corresponding to the delivery slot, the delivery of the package L registered for each delivery slot. Although not limited thereto, packages for one or two destinations may be registered in the delivery slot of the unmanned vehicle, for example, and packages for many destinations such as five to ten destinations may be registered in the delivery slot of the delivery person, for example.

FIG. 2 is an explanatory diagram for describing an example of the delivery slots according to the present embodiment. For example, a daily delivery plan DS of the unmanned vehicle 10B (or the delivery person) is divided into prescribed delivery slots (for example, 15 minutes), and the unmanned vehicle 10B (or the delivery person) delivers, during the time corresponding to the delivery slot, the package L registered for each delivery slot. Such a combination of the delivery plan DS and the delivery slots may be set for each of a plurality of receiving location candidates.

For example, a delivery plan DS set at a certain receiving location (for example, a relay location S1, S2, or the like illustrated in FIG. 8) has two kinds that are: “full” delivery slot (referred to as “full slot DF” hereinafter) indicating that the delivery schedule of the unmanned vehicle 10B (or the delivery person) is already filled; and “empty” delivery slot (referred to as “empty slot DE” hereinafter) indicating that there is an available space in the delivery schedule of the unmanned vehicle 10B (or the delivery person).

The overview of the information processing system according to the present embodiment is described heretofore. Subsequently, examples of the functional configurations of the information terminal 20, the operation management server 30, and the schedule management server 40 according to the present embodiment will be described in order.

### 1.2. Example of Functional Configuration of Information Processing Terminal 20

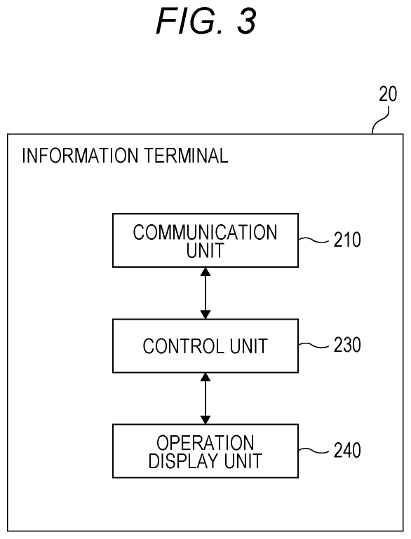

FIG. 3 is an explanatory diagram for describing an example of the functional configuration of the information terminal 20 according to the present embodiment. As illustrated in FIG. 3, the information terminal 20 according to the present embodiment includes a communication unit 210, a control unit 230, and an operation display unit 240.

### (Communication Unit 210)

The communication unit 210 according to the present embodiment performs various kinds of communication with the operation management server 30 and the schedule management server 40. For example, the communication unit 210 provided to the client terminal 20B may transmit a delivery request for delivery or collection of a package registered by the client to the operation management server 30.

The communication unit 210 provided to the delivery person terminal 20A may receive other delivery instruction information from the operation management server 30 based on a determination that the condition regarding the delivery efficiency of the delivery person is satisfied.

### (Control Unit 230)

The Control unit 230 according to the present embodiment controls the overall operation of the information terminal 20. For example, the control unit 230 controls transmission and reception of various kinds of information performed by the communication unit 210. For example, the control unit 230 provided to the client terminal 20B may perform control to cause the communication unit 210 to transmit a delivery request including the request details input via the operation display unit 240.

The control unit 230 may also perform control to display delivery instruction information received from the operation management server 30 on the operation display unit 240. For example, the control unit 230 provided to the delivery person terminal 20A may also perform control to display other delivery instruction information received from the operation management server 30 on the operation display unit 240.

### (Operation Display Unit 240)

The operation display unit 240 according to the present embodiment has a function as an operation unit for inputting the request details related to delivery or collection of a package. The operation display unit 240 also has a function as a display unit for displaying delivery instruction information received from the operation management server 30.

The function as the operation unit can be achieved, for example, by a touch panel or a keyboard, for example.

Furthermore, the function as the display unit can be achieved by a cathode ray tube (CRT) display device, a liquid crystal display (LCD), or an organic light emitting diode (OLED) device. Note that the function as the display unit and the function as the operation unit may be configured separately.

The information terminal 20 may include a microphone, not illustrated in FIG. 3. In that case, the client may use the microphone to voice-input the request details regarding delivery or collection of a package. The information terminal 20 may further include a speaker, not illustrated in FIG. 3. In that case, the delivery person may check the delivery instruction information by the voice output from the speaker.

### 1.3. Example of Functional Configuration of Operation Management Server 30

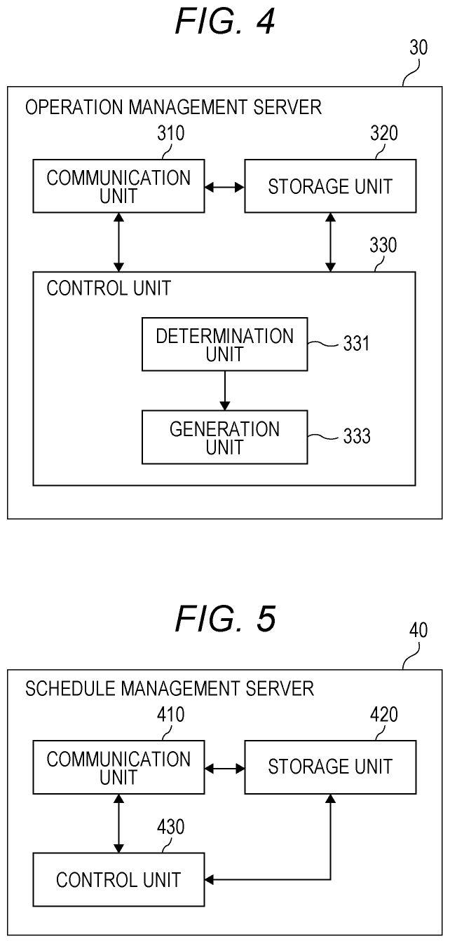

FIG. 4 is an explanatory diagram for describing an example of the functional configuration of the operation management server 30 according to the present embodiment.

The operation management server 30 according to the present embodiment includes a communication unit 310, a storage unit 320, and a control unit 330, as illustrated in FIG. 4.

### (Communication Unit 310)

The communication unit 310 according to the present embodiment performs various kinds of communication with the information terminal 20 and the schedule management server 40. For example, the communication unit 310 may receive a delivery request for delivery or collection of a package registered by the client from the client terminal 20B.

The communication unit 310 may also transmit, to the schedule management server 40, the result of the determination as to whether having the delivery person responding to the delivery request satisfy the condition regarding the delivery efficiency of the delivery person.

Furthermore, the communication unit 310 may receive various kinds of delivery information such as delivery means, delivery slot, and the like transmitted from the schedule management server 40 as a response to the determination result.

The communication unit 310 may also transmit the delivery instruction information generated by a generation unit 333 described later to an external device such as the information terminal 20, the unmanned vehicle 10B, or the like.

### (Storage Unit 320)

The storage unit 320 according to the present embodiment holds software and various kinds of data. For example, the storage unit 320 may hold client information. Note here that the client information may include, for example, various kinds of basic information such as the name of the client, the client name within the service, e-mail address, address, or telephone number, or it may include one or more kinds of information from identification information (ID) of the client, account information of an external application, and information regarding the package receiving location. However, client information is not limited thereto.

Furthermore, the storage unit 320 may also hold delivery person information. Note here that the delivery person information may include, for example, the basic information of the delivery person such as the name of the delivery person, e-mail address, and telephone number, may include identification information of the delivery person, current location information, current delivery area, mobile body type identification information, and the like, and may include the name of the delivery company and delivery company identification information. The delivery person information may also include, for example, external application account information, desired delivery area, identification information (including driver's license information), transfer account information, and delivery history information, and the like. However, the delivery person information is not limited thereto.

Furthermore, the storage unit 320 may also hold store information. For example, store information may include basic information of the store such as store name, business hours, address, contact information, phone number, store URL, shipping charges, and the like. The store information may also include information regarding the products, such as product names, product identification information, product corresponding storage container type information, weight information, and controlled temperature zone information, and the like. However, the store information is not limited thereto.

### (Control Unit 330)

The control unit 330 according to the present embodiment controls the overall operation of the operation management server 30. As illustrated in FIG. 4, for example, the control unit 330 includes a determination unit 331 and a generation unit 333.

The determination unit 331 according to the present embodiment determines whether having a certain delivery person responding to a delivery request satisfies the condition regarding the delivery efficiency of the delivery person, based on the request details included in the delivery request for delivery or collection of the package registered by the client.

Based on the determination made by the determination unit 331 that the condition is not satisfied, the generation unit 333 according to the present embodiment generates delivery instruction information regarding delivery or collection of the package by other delivery means different from the delivery person.

For example, the generation unit 333 may generate delivery instruction information using various kinds of delivery information such as delivery means, delivery slot, and the like designated by the schedule management server 40 based on the determination result of the determination unit 331.

The generation unit 333 may also generate other delivery instruction information regarding delivery or collection of the package by the delivery person based on the determination made by the determination unit 331 that the condition is satisfied.

### 1.4. Example of Functional Configuration of Schedule Management Server 40

FIG. 5 is an explanatory diagram for describing an example of the functional configuration of the schedule management server 40 according to the present embodiment.

The schedule management server 40 according to the present embodiment includes a communication unit 410, a storage unit 420, and a control unit 430, as illustrated in FIG. 5.

### (Communication Unit 410)

The communication unit 410 according to the present embodiment performs various kinds of communication with the information terminal 20 and the operation management server 30. For example, the communication unit 410 may receive the result of the determination as to whether having the delivery person responding to the delivery request satisfies the condition regarding the delivery efficiency of the delivery person.

The communication unit 410 may also transmit, to the operation management server 30, various kinds of delivery information such as the delivery means, delivery slot, and the like designated based on the received determination result.

### (Storage Unit 420)

The storage unit 420 according to the present embodiment holds software and various kinds of data. For example, the storage unit 420 holds delivery plans of each delivery person and delivery plans of the unmanned vehicle 10B. For example, a delivery plan includes various kinds of information such as the package loading status of each delivery slot of the manned mobile body 10A used by the delivery person for delivery, the availability of the unmanned vehicle 10B, and the like.

### (Control Unit 430)

The control unit 430 according to the present embodiment controls the overall operation of the schedule management server 40. For example, the control unit 430 designates various kinds of delivery information such as the delivery means, delivery time, and the like based on the result of determination as to whether having the delivery person responding to the delivery request satisfies the condition regarding the delivery efficiency of the delivery person.

For example, upon receiving a determination result including the fact that the condition regarding the delivery efficiency is satisfied, the control unit 430 may designate delivery by a delivery person using the manned mobile body 10A, and may insert the delivery in a prescribed order in the delivery plan of a prescribed delivery person or may designate a delivery slot according to the availability included in the delivery plan of the delivery person. The control unit 430 may also control the communication unit 410 to transmit the delivery information including the designated delivery means (delivery person) and delivery slot to the operation management server 30, or to change the delivery plan of a prescribed delivery vehicle.

Upon receiving a determination result including the fact that the condition regarding the delivery efficiency is not satisfied, the control unit 430 may designate delivery by the unmanned vehicle 10B, and may designate a delivery slot in accordance with the availability in the delivery plan of the unmanned vehicle 10B. Furthermore, the control unit 430 may control the communication unit 410 to transmit the delivery information including the designated delivery means (the unmanned vehicle 10B) and delivery slot to the operation management server 30.

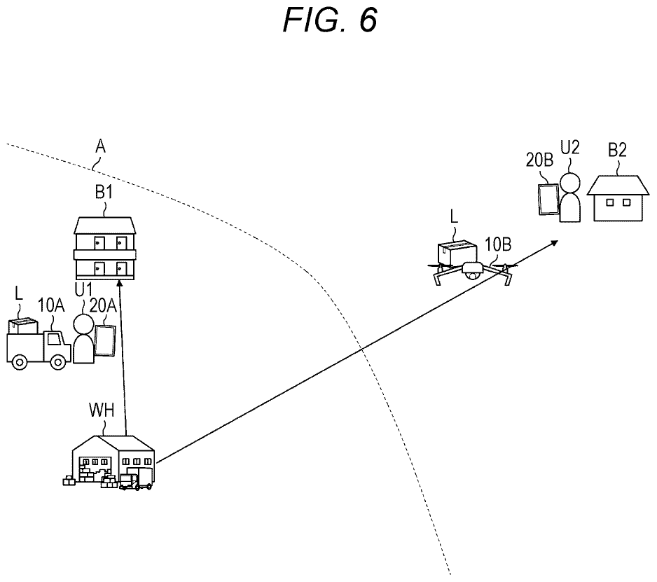

The examples of the functional configurations of the information terminal 20, the operation management server 30, and the schedule management server 40 according to the present embodiment are described heretofore. Subsequently, referring to FIG. 6 to FIG. 8, a specific example related to processing for determining whether the condition regarding the delivery efficiency is satisfied will be described.

### 2. Specific Example of Processing for Determining Whether Condition regarding Delivery Efficiency is Satisfied

When a client requests delivery or collection of a package such as food or daily necessities through an application or a browser, a delivery person may be assigned to handle the delivery request for the package.

For example, a delivery person who responds to a delivery request of a package requested by a client needs to go to the warehouse or the store where the package is stored to collect the package as necessary. As a result, when the location where the package is to be collected is far from the location where the delivery person is at, it is necessary to travel a long distance to collect the package, thereby reducing the delivery efficiency of the delivery person.

Furthermore, a delivery request of a client may include a variety of demands. For example, a delivery request may include various kinds of demands such as a delivery slot, a package receiving location, and the like. The delivery request can also include a prescribed demand such as immediate delivery of a package (for example, food and the like).

When such a prescribed demand is included, the delivery plan of the delivery person may be affected by going to the warehouse or the store where the package is stored to collect the package as soon as it is determined that the delivery person is to handle the delivery of the package. In other words, when the delivery person responds to such irregular request as necessary, the delivery efficiency of the delivery person may be reduced.

In order to reduce the burden on the delivery person and to suppress reduction in the delivery efficiency, it may be desirable to have the unmanned vehicle 10B, for example, assist in the delivery of the package that is requested to be delivered by an irregular request.

Therefore, the information processing system according to the present embodiment determines whether having a delivery person responding to a delivery request of a certain package satisfies the condition regarding the delivery efficiency of the delivery person and, when the condition regarding the delivery efficiency of the delivery person is not satisfied (for example, when the delivery request is an irregular request as described above), has the unmanned vehicle 10B assist delivery or collection of the package. Hereinafter, specific examples related to processing for determining whether the condition regarding the delivery efficiency of the delivery person is satisfied will be described in order.

FIG. 6 is an explanatory diagram for describing an example of processing for determining whether the condition regarding the delivery efficiency is satisfied. For example, a case will be described in which, for the delivery person Ul, a delivery area A is designated as the area where the delivery person Ul is in charge of delivering the package L. In the examples illustrated in FIG. 6 to FIG. 8, inside the delivery area A of the delivery person Ul is the left side of the dashed line that indicates the boundary of the delivery area A, and outside the delivery area A is the right side of the dashed line that indicates the boundary of the delivery area A.

In the examples illustrated in FIG. 6 to FIG. 8, the package L is illustrated by being exposed to the outside the mobile bodies 10 for convenience of explanation.

However, the package L may be stored inside the mobile bodies 10. The unmanned vehicle 10B may also have a structure to grasp the package L.

For example, the determination unit 331 may determine whether the condition regarding the delivery efficiency of the delivery person Ul is satisfied based on the receiving location of the package L included in the request details of the client U2.

For example, when a home B2 (or receiving location or collection location such as a store, dedicated delivery facility, or the like near the home B2) not included within the delivery area A as illustrated in FIG. 6 is designated as the receiving location or a collection location of the package L, the determination unit 331 may determine that the condition regarding the delivery efficiency of the delivery person Ul is not satisfied.

When determined that the condition regarding the delivery efficiency of the delivery person Ul is not satisfied, the generation unit 333 may generate delivery instruction information regarding delivery or collection of the package L by the unmanned vehicle 10B that is delivery means different from the delivery person Ul.

Then, the communication unit 310 may transmit the delivery instruction information generated by the generation unit 333 to the unmanned vehicle 10B. In this case, the unmanned vehicle 10B upon receiving the delivery instruction information may deliver the package L by autonomous control based on the received delivery instruction information.

The communication unit 310 may also transmit the delivery instruction information generated by the generation unit 333 to the information terminal 20 that is used by the administrator of the unmanned vehicle 10B. In this case, the administrator may remotely operate the unmanned vehicle 10B based on the delivery instruction information, or may transmit the delivery instruction information to the unmanned vehicle 10B by using the information terminal 20 that is used by the administrator.

Note that the delivery instruction information includes, for example, various kinds of information used for autonomous control of the unmanned vehicle 10B and for remote control of the unmanned vehicle 10B. For example, the delivery instruction information may include information regarding the package delivery start location and the receiving location of the client for the package L, or may include information regarding the delivery route, the via point, and the like.

Furthermore, when a home B1 included within the delivery area A is designated as the receiving location or the collection location of the package L, the determination unit 331 may determine that the condition regarding the delivery efficiency of the delivery person Ul is satisfied.

When determined that the condition regarding the delivery efficiency of the delivery person Ul is satisfied, the generation unit 333 may generate other delivery instruction information regarding delivery or collection of the package L by the delivery person Ul.

Then, the communication unit 310 may transmit other delivery instruction information generated by the generation unit 333 to the delivery person terminal 20A that is an external device used by the delivery person Ul.

Note that other delivery instruction information regarding delivery or collection of the package by the delivery person U1 may be or may not be the same as the delivery instruction information regarding delivery or collection of the package by other delivery means (for example, the unmanned vehicle 10B). For example, other delivery instruction information may include information regarding delivery assistance for the delivery person U1 (for example, the order in which deliveries are made, traffic congestion level, or the like).

Also, the operation management server 30 may not necessarily need to transmit delivery instruction information or other delivery instruction information to the external device. For example, in a case where the operation management server 30 includes a display unit, delivery instruction information and other delivery instruction information may be displayed on the display unit. Then, the administrator upon checking the delivery instruction information displayed on the display unit may instruct the delivery person Ul or the unmanned vehicle 10B to make the delivery using an arbitrary method.

According to the example described above, the unmanned vehicle 10B assists delivery of the package for a delivery request demanding delivery to other areas not included in the delivery area A (for example, exclaves indicating places that are distant or geographically isolated, and the like). As a result, the delivery person Ul can focus on the deliveries within the delivery area A, which makes it possible to further improve the delivery efficiency of the delivery person U1.

While the warehouse WH is mentioned as an example of a place where the packages L are stored, the warehouse WH may be a warehouse owned by each delivery company, or it may be a warehouse where the storage space and sorting space are shared by a plurality of delivery companies.

Furthermore, when the delivery plan of the delivery person Ul does not include a schedule to deliver other packages within a prescribed range from the receiving location or collection location of the package L that is newly requested to deliver, the determination unit 331 may determine that the condition regarding the delivery efficiency is not satisfied. This allows the delivery person Ul to respond to a delivery request only when other packages are scheduled to be delivered in the neighborhood thereof, which makes it possible to further improve the delivery efficiency of the delivery person U1.

Also, the delivery area A where the delivery person Ul is in charge may vary depending on the time and date. In this case, the determination unit 331 may determine whether the condition regarding the delivery efficiency is satisfied based on the desired delivery time and desired delivery date included in the request details.

For example, a certain delivery person U1 may be in charge of delivery in a first delivery area (for example, east area) in the morning and may be in charge of delivery in a second delivery area (for example, west area). In this case, when a receiving location or a collection location is designated at a location included in the first delivery area and the request details include that the desired delivery time is in the morning, for example, the determination unit 331 may determine that the condition regarding the delivery efficiency is satisfied since it is the time where the delivery person Ul is in charge of the first delivery area.

In the meantime, when a receiving location or a collection location is designated at a location included in the first delivery area and the request details include that the desired delivery time is in the afternoon, the determination unit 331 may determine that the condition regarding the delivery efficiency is not satisfied since it is the time where the delivery person Ul is not in charge of the first delivery area.

Furthermore, in the example illustrated in FIG. 6, the base of the unmanned vehicle 10B and the warehouse WH where the package L is stored are described as the delivery start location. However, the delivery start location according to the present embodiment is not limited to such cases.

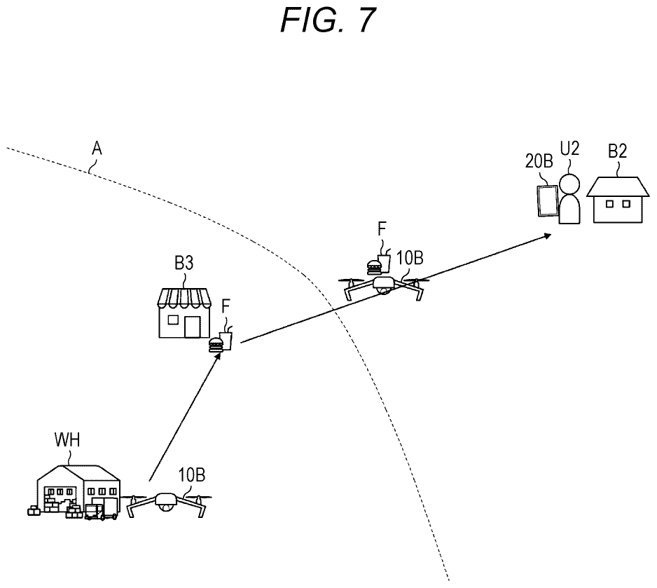

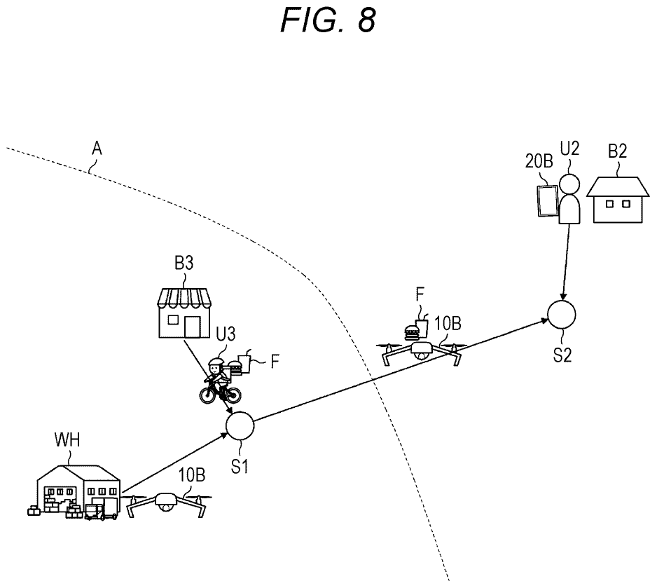

Referring now to FIG. 7, an example in which the delivery start location is not the base of unmanned vehicle 10B (for example, a case where a package to be delivered is at a location different from the base of the unmanned vehicle 10B) will be described.

FIG. 7 is an explanatory diagram for describing another example of the processing for determining whether the condition regarding the delivery efficiency is satisfied. For example, the base of the unmanned vehicle 10B (the warehouse WH illustrated in FIG. 7) and the delivery start location may not necessarily be the same. For example, as illustrated in FIG. 7, the unmanned vehicle 10B may collect the food F at a store B3 where the food F included in the delivery request is at. While the food F is mentioned as an example of the package in the example illustrated in FIG. 7, it may also be any other package.

Even when the store B3 for collecting the food F is included within the delivery area A as illustrated in FIG. 7 but the home B2 as the receiving location of the client U2 is not included within the delivery area A, the determination unit 331 may determine that the condition regarding the delivery efficiency is not satisfied.

Also, even when the home B2 as the receiving location is included within the delivery area A but the store B3 for collecting the food F is not included within the delivery area A, the determination unit 331 may determine that the condition regarding the delivery efficiency is not satisfied.

In the meantime, when the store B3 for collecting the food F and the home B2 as the receiving location are both included within the delivery area A, the determination unit 331 may determine that the condition regarding the delivery efficiency is satisfied.

Furthermore, while the store B3 is illustrated as the location for collecting the food F (may be expressed as a collection location hereinafter) and the home B2 is illustrated as the receiving location in the example illustrated in FIG. 7, the collection location and the receiving location of the package L are not limited to buildings and facility such as the home B2 and the store B3. Referring now to FIG. 8, other examples of the collection location and the receiving location will be described.

FIG. 8 is an explanatory diagram for describing other examples of the collection location and the receiving location according to the present embodiment. For example, the collection location and the receiving location may be the relay locations S1 and S2, as illustrated in FIG. 8.

For example, the relay locations S1 and S2 may be the locations of stands where the unmanned vehicle 10B can be on standby. For example, a certain transporter U3 may collect the food F requested to be delivered by the client U2 at the store B3. The transporter U3 may then transport the food F from the store B3 to the relay location S1.

The unmanned vehicle 10B may then receive the food F from the transporter U3 using the relay location S1 as the collection location, for example. Note that the transporter U3 herein may be any transporter such as a clerk at the store B3, a gig worker, or a customer of the store B3, for example.

The unmanned vehicle 10B upon receiving the hood F from the transporter U3 may then deliver the food F from the relay location S1 to the relay location S2 that is designated by the client U2 as the receiving location.

Note that the unmanned vehicle 10B may be on standby at the relay location $2 until the client U2 arrives at the relay location S2. The unmanned vehicle 10B may also drop the package at the relay location S2 and return to the warehouse WH without waiting for the client U2 to arrive at the relay location $2, or may leave the food F in a storage box and return to the warehouse WH when the house box is placed at the relay location S2. Furthermore, when the client U2 receives the package from the standby unmanned vehicle 10B or the storage box, delivery authentication may be performed using prescribed identification information.

This allows more options for the receiving locations for the client U2, such as the nearest bus stop or train station of the client U2, for example, which makes it possible to further improve the convenience for the client U2.

Note that the relay locations S1 and S2 are not limited to the locations of stands where the unmanned vehicle 10B can be on standby. While the relay locations S1 and S2 may be any meeting locations, it is desirable to be a location serving as landmark such as a bus stop, a building, or a parking lot, for example.

Other examples of the collection location and the receiving location according to the present embodiment are described heretofore. As described above, a delivery request may include a variety of demands. Thus, the determination unit 331 may determine whether the condition regarding the delivery efficiency is satisfied by using, for example, various kinds of factors that affect the delivery efficiency of the delivery person.

For example, it is assumed that a new delivery request is added when a delivery person is delivering a plurality of packages in a certain delivery area. Here, when the newly added delivery request includes a prescribed demand such as urgent delivery or the like, the delivery person may need to give priority to collect the package corresponding to the prescribed demand and deliver it to the client.

This may affect the delivery plan of a plurality of packages that are initially being delivered by the delivery person. Thus, the determination unit 331 may determine that the condition regarding the delivery efficiency of the delivery person is not satisfied when the request details include a prescribed demand that affects the delivery plan of the delivery person. The delivery person information may include additional tolerance information (for example, additional allowable-number-of-times information, additional allowable time information, additional allowable distance information, and the like), and the determination unit 331 may determine that the condition regarding the delivery efficiency of the delivery person is satisfied when the new delivery request is within an allowable range indicated by the additional tolerance information.

Furthermore, even when the delivery area is not designated by the delivery person, the determination unit 331 may determine that the condition regarding the delivery efficiency of the delivery person is not satisfied when the distance from the package delivery start location to the receiving location is equal to or greater than a prescribed value.

Furthermore, when the unmanned vehicle 10B is placed within a prescribed range from the store B3 that is the delivery start location of the food F as illustrated in FIG. 7, for example, it may be more efficient to deliver the food F by the unmanned vehicle 10B. Thus, when the package delivery start location is included within a prescribed range from the location of the unmanned vehicle 10B that can be used for delivery or collection of the package, the determination unit 331 may determine that the condition regarding the delivery efficiency of the delivery person is not satisfied. Alternatively, instead of determining that the condition regarding the delivery efficiency of the delivery person is not satisfied, the delivery by the unmanned vehicle 10B may be designated regardless of the delivery efficiency of the delivery person.

Furthermore, when the package delivery start location is the same as the location of the unmanned vehicle 10B that can be used for delivery or collection of the package, the determination unit 331 may determine that the condition regarding the delivery efficiency of the delivery person is not satisfied. For example, when the unmanned vehicle 10B is placed at the store B3 that is the delivery start location of the food F as illustrated in FIG. 7, the determination unit 331 may determine that the condition regarding the delivery efficiency of the delivery person is not satisfied. Alternatively, instead of determining that the condition regarding the delivery efficiency of the delivery person is not satisfied, the delivery by the unmanned vehicle 10B may be designated regardless of the delivery efficiency of the delivery person.

Alternatively, when the package requested by the client to deliver is at the warehouse WH that is the base of the unmanned vehicle 10B (or when the package requested to be delivered is directly brought in to the warehouse WH by the client), the determination unit 331 may determine that the condition regarding the delivery efficiency of the delivery person is not satisfied. Alternatively, instead of determining that the condition regarding the delivery efficiency of the delivery person is not satisfied, the delivery by the unmanned vehicle 10B may be designated regardless of the delivery efficiency of the delivery person. This makes it possible to promote the use of the unmanned vehicle 10B and to further reduce the burden on the delivery person.

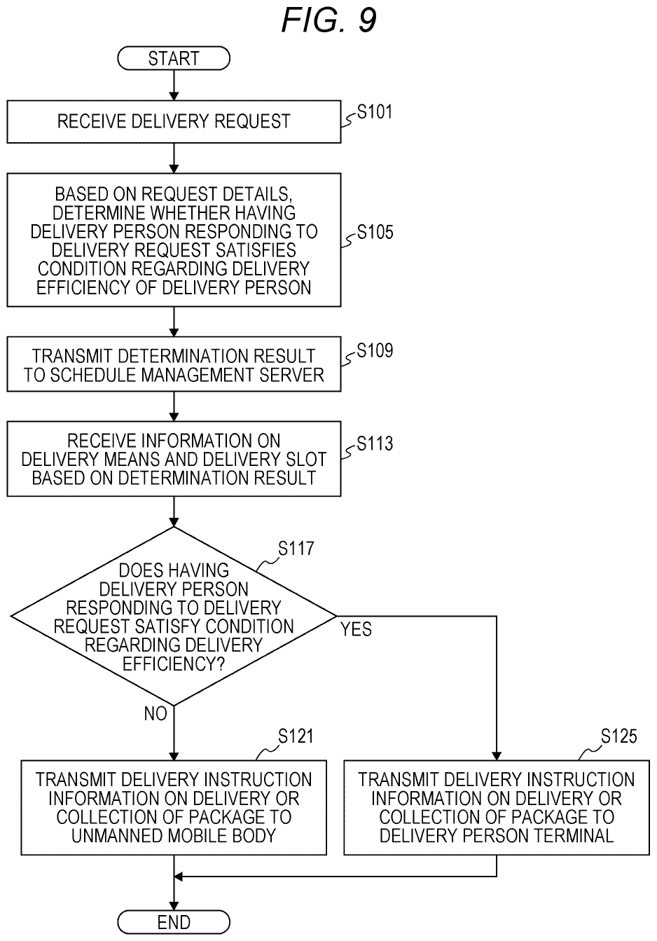

Another example of the processing for determining whether the condition regarding the delivery efficiency is satisfied is described heretofore. Referring now to FIG. 9, an example of operation processing of the operation management server 30 according to the present embodiment will be described.

### 3. Operation Processing Example

FIG. 9 is an explanatory diagram for describing an example of the operation processing of the operation management server 30 according to the present embodiment. First, the communication unit 310 receives a delivery request from the client terminal 20B (S101).

Then, the determination unit 331 determines whether having the delivery person responding to the delivery request satisfies the condition regarding the delivery efficiency of the delivery person, based on the request details included in the received delivery request (S105).

Then, the communication unit 310 transmits, to the schedule management server 40, the result of determination as to whether having the delivery person responding to the delivery request satisfies the condition regarding the delivery efficiency of the delivery person (S109).

Subsequently, the communication unit 310 receives, from the schedule management server 40, information regarding the delivery means and the delivery slot based on the determination result (S113).

Then, the control unit 330 determines whether it is determined by the determination unit 331 at S105 that having the delivery person responding to the delivery request satisfies the condition regarding the delivery efficiency (S117). When it is determined that having the delivery person responding to the delivery request does not satisfy the condition regarding the delivery efficiency (No at S117), the processing is shifted to S121. When it is determined that having the delivery person responding to the delivery request satisfies the condition regarding the delivery efficiency (Yes at S117), the processing is shifted to S125.

When it is determined that having the delivery person responding to the delivery request does not satisfy the condition regarding the delivery efficiency (No at S117), the generation unit 333 generates delivery instruction information regarding delivery or collection of the package, the communication unit 310 transmits the generated delivery instruction information to the unmanned vehicle 10B (S121), and the operation management server 30 according to the present embodiment ends the operation processing.

When it is determined that having the delivery person responding to the delivery request satisfies the condition regarding the delivery efficiency (Yes at S117), the generation unit 333 generates other delivery instruction information regarding delivery or collection of the package, the communication unit 310 transmits the other generated delivery instruction information to the delivery person terminal 20A (S125), and the operation management server 30 ends the operation processing.

### 4. Hardware Configuration Example

The information processing described above is achieved through cooperation of software and hardware of the operation management server 30 described below. Note that the hardware configuration described below is also applicable to the information terminal 20 and the schedule management server 40.

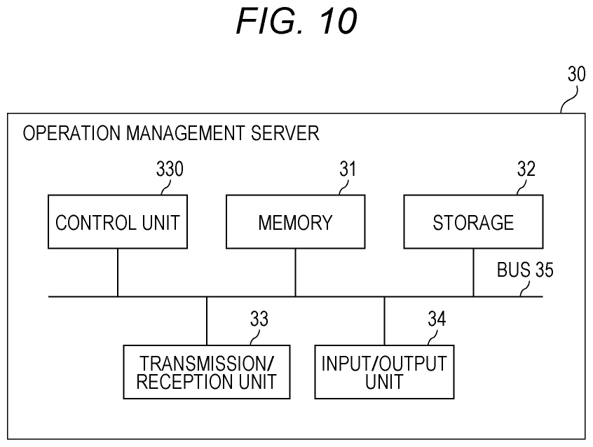

FIG. 10 is an explanatory diagram for describing an example of the hardware configuration of the operation management server 30 according to the present embodiment. As illustrated in FIG. 10, for example, the operation management server 30 includes a control unit 330, a memory 31, a storage 32, a transmission/reception unit 33, an input/output unit 34, and the like, which are electrically connected to each other via a bus 35.

The control unit 330 is an arithmetic device that controls the overall operation of the operation management server 30, controls transmission and reception of data between each of the elements, executes applications, and performs information processing and the like necessary for authentication processing. For example, the control unit 330 is a central processing unit (CPU) and/or a graphics processing unit (GPU), which executes programs and the like for the system stored in the storage 32 and expanded on the memory 31 to perform various kinds of information processing as described above.

The memory 31 includes a main memory that is configured with a volatile storage device such as dynamic random access memory (DRAM) or the like, and an auxiliary memory that is configured with a non-volatile storage device such as a flash memory, a hard disc drive (HDD), or the like. The memory 31 is used as a work area and the like of the control unit 330, and also stores the basic input/output system (BIOS) executed when starting the operation management server 30 as well as various kinds of setting information and the like.

The storage 32 stores various kinds of programs such as application programs and the like. A database that stores the data used for each kinds of processing may be built in the storage 32.

The transmission/reception unit 33 connects the operation management server 30 to the network and/or blockchain network. Note that the transmission/reception unit 33 may include near field communication interfaces of Bluetooth (registered trademark) and Bluetooth Low Energy (BLE).

The input/output unit 34 is an information input device such as a keyboard, a microphone, a mouse, and the like and an output device such as a display, a speaker, and the like.

The bus 35 is commonly connected to each of the above elements and transmits, for example, address signals, data signals, and various kinds of control signals.

### 5. Supplement

The preferable embodiment of the present invention is described above in detail with reference to the accompanying drawings. However, the present invention is not limited to such examples. It is readily apparent to those having ordinary knowledge and skilled in the art to which the present invention belongs that various modifications and substitutions can be made without departing from the technical spirit and scope of the appended claims, and that those naturally fall within the technical scope of the present invention.

For example, when it is determined by the determination unit 331 that having a first delivery person who makes deliveries in a first delivery responding to a certain delivery request does not satisfy the condition regarding the delivery efficiency of the first delivery person, the generation unit 333 may generate delivery instruction information for a second delivery person who makes deliveries in a second delivery area. Furthermore, when it is determined that the condition regarding the delivery efficiency of the first delivery person is not satisfied and that delivery by the unmanned vehicle 10B is not appropriate (for example, there is no available unmanned vehicle 10B, it takes time to charge the unmanned vehicle 10B, the package L exceeds the loadable weight and loadable size of the unmanned vehicle 10B, it is not in an acceptable temperature range, and the like), the generation unit 333 may generate delivery instruction information for the second delivery person who makes deliveries in the second delivery area. By having a person assist a person in this way, it is possible to handle various situations, such as a case where the unmanned vehicle 10B is not at the base, a case where it is more efficient to have it delivered by a person, and the like.

In addition, while the present specification mainly describes an example in which a delivery person uses the mobile body 10 to deliver the package, the delivery person does not necessarily need to use the mobile body 10. For example, the delivery person may deliver the package on foot.

The determination unit 331 may also determine whether the condition regarding the delivery efficiency of the delivery person is satisfied based on various kinds of information such as delivery person information, store information, information regarding the products, and the like held at the storage unit 320. For example, when the weight of the package requested to be delivered by a client exceeds a prescribed criterion (for example, exceeds the loadable weight of the unmanned vehicle 10B), delivery by the unmanned vehicle 10B is considered difficult, and the determination unit 331 may determine that the condition regarding the delivery efficiency of the delivery person is satisfied.

Furthermore, the operation management server 30 according to the present embodiment may include some or all of the functional configuration of the schedule management server 40. When the operation management server 30 has all the functional configuration of the schedule management server 40, the information processing system according to the present embodiment may not need to include the schedule management server 40.

Furthermore, the schedule management server 40 may include some or all of the functional configuration of the operation management server 30. For example, the schedule management server 40 may have the configuration having the functions of the determination unit 331 and the generation unit 333.

It is also possible to create a computer program for causing hardware such as a CPU, a ROM, a RAM, and the like built into the information terminal 20, the operation management server 30, and the schedule management server 40 to achieve the same functions as those of the information terminal 20, the operation management server 30, and the schedule management server 40 described above.

### REFERENCE SIGNS LIST

10 Mobile body
20 Information terminal
210 Communication unit
230 Control unit
240 Operation display unit
30 Operation management server
310 Communication unit
320 Storage unit
330 Control unit
331 Determination unit
333 Generation unit
40 Schedule management server
410 Communication unit
420 Storage unit
430 Control unit

1. An information processing system comprising:
a determination unit that determines, based on request details included in a delivery request regarding delivery or collection of a package registered by a delivery client, whether having a delivery person responding to the delivery request satisfies a condition regarding delivery efficiency of the delivery person; and
a generation unit that generates, based on a determination made by the determination unit that the condition is not satisfied, delivery instruction information regarding delivery or collection of the package by other delivery means different from the delivery person.

2. The information processing system according to claim 1, further comprising a communication unit that transmits the delivery instruction information generated by the generation unit to an external device.

3. The information processing system according to claim 2, wherein the external device includes an information terminal used by an administrator that manages an unmanned vehicle.

4. The information processing system according to claim 2, wherein the external device includes an unmanned vehicle.

5. The information processing system according to claim 4, wherein the delivery person delivers the package using a mobile body.

6. The information processing system according to claim 5, wherein the mobile body includes a vehicle that travels on a land route.

7. The information processing system according to claim 6, wherein the unmanned vehicle includes a mobile body that autonomously travels on the land route.

8. The information processing system according to claim 6, wherein the unmanned vehicle includes a mobile body that autonomously travels on a route different from the land route.

9. The information processing system according to claim 8, wherein the unmanned vehicle includes an aircraft that autonomously flies on an air route.

10. The information processing system according to claim 1, wherein the determination unit determines whether the condition is satisfied, based on a receiving location of the package included in the request details.

11. The information processing system according to claim 1, wherein the determination unit determines whether the condition is satisfied, based on a delivery area of the delivery person.

12. The information processing system according to claim 1, wherein the determination unit determines that the condition is not satisfied when a prescribed demand that affects a delivery plan of the delivery person is included in the request details.

13. The information processing system according to claim 3, wherein the determination unit determines that the condition is not satisfied when a delivery start location of the package is within a prescribed range from a location of the unmanned vehicle that is capable of being used for delivery of the package.

14. The information processing system according to claim 3, wherein the determination unit determines that the condition is not satisfied when a delivery start location of the package is same as a location of the unmanned vehicle that is capable of being used for delivery or collection of the package.

15. The information processing system according to claim 3, wherein the generation unit generates other delivery instruction information regarding delivery or collection of the package to be performed by delivery means of the delivery person, based on a determination made by the determination unit that the condition is satisfied.

16. The information processing system according to claim 15, wherein the communication unit transmits the other delivery instruction information to a terminal used by the delivery person.

17. An information processing device comprising:
a determination unit that determines, based on request details included in a delivery request regarding delivery or collection of a package registered by a delivery client, whether having a delivery person responding to the delivery request satisfies a condition regarding delivery efficiency of the delivery person; and
a generation unit that generates, based on a determination made by the determination unit that the condition is not satisfied, delivery instruction information regarding delivery or collection of the package by other delivery means different from the delivery person.

18. An information processing method executed by a computer, the information processing method comprising:
determining, based on request details included in a delivery request regarding delivery or collection of a package registered by a delivery client, whether having a delivery person responding to the delivery request satisfies a condition regarding delivery efficiency of the delivery person; and
generating, based on a determination that the condition is not satisfied, delivery instruction information regarding delivery or collection of the package by other delivery means different from the delivery person.

19. A program causing a computer to execute:
a determination function that determines, based on request details included in a delivery request regarding delivery or collection of a package registered by a delivery client, whether having a delivery person responding to the delivery request satisfies a condition regarding delivery efficiency of the delivery person; and
a generation function that generates, based on a determination made by the determination function that the condition is not satisfied, delivery instruction information regarding delivery or collection of the package by other delivery means different from the delivery person.
